(19) United States
(12) Patent Application Publication
(10) Pub. No.: US 2002/0024215 A1
(43) Pub. Date: Feb. 28, 2002

(54) Method of preventing counterfeiting

(76) Inventor: Kam Fu Wong, Shatin (HK)

Correspondence Address: IPSOLON LLP, 805 SW BROADWAY, #2740, PORTLAND, OR, 97205, US

(21) Appl. No.: 09/876,907

(22) Filed: Jun. 8, 2001

(30) Foreign Application Priority Data
Jun. 22, 2000 (CN) 00109700.5
Sep. 22, 2000 (EP) 00120749.7

(51) Int. Cl. B42D 15/00

(52) U.S. Cl. 283/72; 283/57

(57) ABSTRACT

A method of preventing counterfeiting of an item, comprising the steps of: providing an item, the authenticity of which is to be verified; providing a bank note having a serial number marked thereon; physically associating the bank note with the item; and marking at least a part of the serial number on the item.

Also disclosed is a combination of an item, the authenticity of which is to be verified, and a bank note having a serial number marked thereon, wherein the bank note is physically associated with the item and the item has at least a part of the serial number of the bank note marked thereon.

THIS INVENTION relates to a method of preventing counterfeiting, and in particular to a method of packaging goods in such a way that the likelihood of counterfeit goods being successfully manufactured and distributed is reduced.

The counterfeiting of goods by unauthorised manufacturers exploiting famous brands or marks has been a persistent problem for many years. Manufacturers jealously guard the reputations of their products so much time and effort is devoted by authentic manufacturers in marking their products in ways that are difficult to reproduce, and examples of techniques used include marking goods with holograms, watermarks, digital watermarks, or with designs that are only visible under certain lighting conditions. However, counterfeiting methods have become increasingly sophisticated, and methods of overcoming such techniques are becoming available to unscrupulous traders.

It is an object of the present invention to provide a method of packaging goods which simply and effectively reduces the possibility of the packaging being reproducible by counterfeiters.

Accordingly, one aspect of the present invention provides a method of preventing counterfeiting of an item, comprising the steps of: providing an item, the authenticity of which is to be verified; providing a bank note having a serial number marked thereon; physically associating the bank note with the item; and marking at least a part of the serial number on the item.

Advantageously, the at least part of the serial number comprises the whole of the serial number.

Preferably, the step of physically associating the bank note with the item comprises the step of rendering the at least part of the serial number visible.

Conveniently, the item includes packaging, and the step of physically associating the bank note with the item comprises the step of physically associating the bank note with the packaging.

Advantageously, the step of physically associating the bank note with the item comprises the step of providing a transparent surface, the bank note being located between the item and the transparent surface.

Preferably, the step of physically associating the bank note with the item comprises the steps of: providing a bag having an at least partially transparent area; and placing the bank note within the bag.

Conveniently, the method further comprises the step of marking the at least part of the serial number of the bank note on the item in at least one further location.

Advantageously, the method further comprises the steps of providing at least one further bank note; and physically associating the at least one further bank note with the item.

Preferably, the step of providing at least one further bank note comprises the step of providing one further bank note.

Conveniently, the step of providing at least one further bank note comprises the step of providing two further bank notes.

Another aspect of the present invention provides a combination of an item, the authenticity of which is to be verified, and a bank note having a serial number marked thereon, wherein the bank note is physically associated with the item and the item has at least a part of the serial number of the bank note marked thereon.

Advantageously, the at least part of the serial number comprises the whole of the serial number.

Preferably, at least part of the bank note is rendered visible.

Conveniently, the combination further comprises a transparent surface, the bank note being located between the item and the transparent surface.

Advantageously, the combination further comprises a bag having an at least partially transparent area, the bank note being located within the bag.

Preferably, the at least part of the serial number is marked in at least one further location on the item.

In order that the present invention may be more readily understood, embodiments thereof will now be described, by way of example, and with reference to the accompanying drawings, in which:

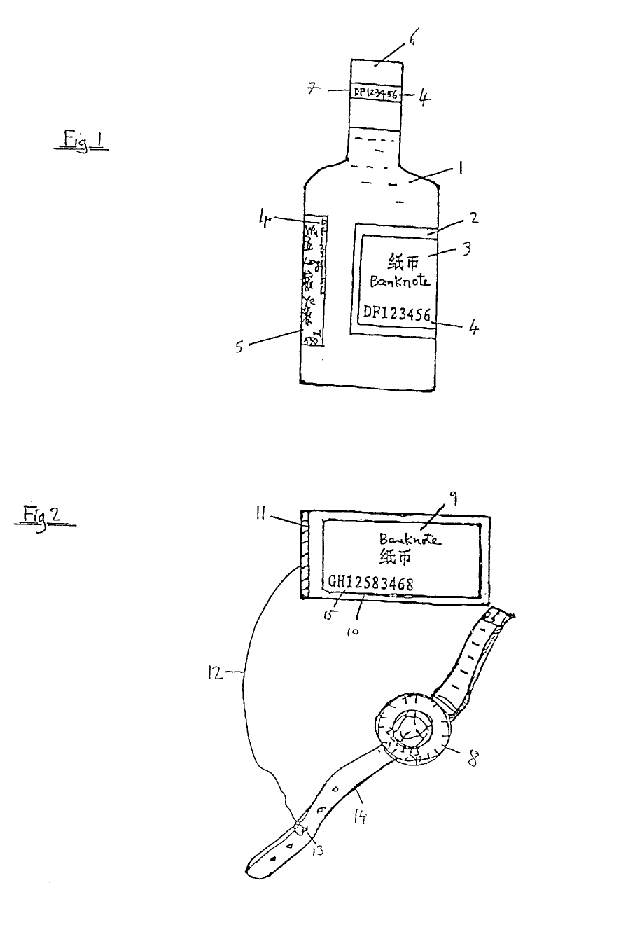

FIG. 1 is a side view of a combination of a bottle and a bank note embodying the present invention; and

FIG. 2 is a plan view of a combination of a watch and a bank note embodying the present invention.

Turning firstly to FIG. 1, a bottle 1 is shown. The bottle I contains a liquid such as a valuable spirit produced by a manufacturer anxious to maintain quality and prevent counterfeit products entering the market. The manufacturer wishes to reassure the purchaser that the content of the bottle comes from a reputable source, ie the manufacturer, and is not counterfeit.

A transparent bag 2 having a bank note 3 sealed therein is attached to part of the curved outer surface of the main body of the bottle 1 by a suitable adhesive. The bank note 3 is presented in the transparent bag 2 in an unfolded manner, and the entirety of one side of the bank note 3, on which a serial number 4 of the bank note 3 is marked, is visible through the transparent bag 2. The transparent bag 2 is preferably waterproof and hermetically sealed, to prevent damage to the bank note 3 arising from the outside of the bottle 1 coming into contact with moisture, dust or the like during storage and display.

The bank note 3 may be folded in the bag, the full serial number being visible.

A conventional label 5 is provided on another region of the curved outer surface of the main body of the bottle 1. The conventional label 5 presents information regarding the contents of the bottle 1, which may include the alcoholic concentration and volume of liquid enclosed therein. Importantly, the serial number 4 of the bank note 3 contained in the bag 2 is marked on the conventional label 5.

The cap 6 of the bottle 1 is formed such that a removable strip 7 must be torn off before the cap 6 can be removed from the bottle 1. The serial number 4 of the bank note 3 is also marked on the removable strip 7.

The above described method provides packaging that is very difficult to replicate. If a counterfeiter makes a copy of the conventional label 5 or the removable strip 7 of the bottle 1, he or she will be extremely unlikely to be in possession of the bank note 3 bearing the serial number 4 that is identical to that printed on the label 5 or the removable strip 7. Hence, the counterfeiter will be unable to present a bottle in which the serial number on the bank note matches the serial number presented on the rest of the packaging. Thus, bottles packaged by a counterfeiter will be immediately identifiable as not being a genuine product.

The packaging of the bottle 1 is rendered additionally difficult to replicate due to the difficulty in forging bank notes. Bank notes are deliberately made extremely difficult to copy. The penalties for forging bank notes are also very harsh and usually are greater than the penalties for counterfeiting commercial products. It would not, in view of this, be in the interests of counterfeiters to attempt to forge bank notes in an attempt to replicate packaging embodying the present invention.

It will be appreciated that the present invention provides a very secure method of preventing counterfeiting of goods.

In a preferred embodiment of the invention, only a part of the serial number 4 is presented on the conventional label 5 and removable strip 7 of the bottle 1. For instance, if the bank note 3 carries a ten-digit serial number, the marking of the final six digits of the serial number would be sufficient to ensure that the product contained in the bottle I is genuine. The probability of a counterfeiter being able to obtain a bank note having a serial number with an identical final six digits to those of the serial number shown on the packaging is extremely remote. In this embodiment of the invention, it is not necessary for the entire serial number 4 of the bank note 3 to be visible, and only those portions of the serial number 4 that are replicated on the remainder of the packaging need be presented.

For additional security, more than one bank note may be presented in the packaging of an object. In this embodiment, a sealed transparent bag sufficiently large to contain two bank notes side by side may be provided on a bottle, the bank notes being located therein. The serial numbers of both bank notes (or significant portions thereof, as described above) would be presented on the remainder of the packaging of the bottle. It will be appreciated that, if two serial numbers are presented on the label of a bottle, the probability of a counterfeiter being able to obtain both necessary bank notes is even less than that of being able to obtain a single specific bank note. The greater the number of bank notes present, the smaller the possibility of reproduction of the packaging of the bottle becomes.

In one embodiment of the invention, the bank note is presented such that an external surface of the sealed bag 2 is opaque, and an inner surface of the bag 2 is transparent. In this embodiment, the material from which the bottle 1 is made, and the liquid contained within the bottle 1, are sufficiently transparent that the serial number 4 of the bank note 3 is visible through one wall of the bottle 1 and the liquid contained therein. In this manner, the present invention may be put into practice without the need for a manufacturer's well-known design of packaging to be disturbed by the presence of a bank note 3 on an external surface of the bottle 1.

It is, of course, not necessary to provide a sealed bag in which to present the bank note 3, and it will be clear to a person of ordinary skill in the art that any form of packaging that allows the serial number of the bank note 3 to be externally inspected will suffice. For example, a single transparent sheet could be adhered to the side of the bottle 1 by the edges thereof, the bank note 3 being provided between the outer surface of the bottle 1 and the transparent sheet.

FIG. 2 shows a watch 8. In this embodiment, a bank note 9 is presented in a sealed transparent bag 10 similar to that provided on the external surface of the bottle 1 described above.

The transparent bag 10 containing the bank note 9 is attached, at one edge 11 thereof, to a length of wire 12. A loop of the wire 12 passes through a hole 13 in a strap 14 of the watch 8. The transparent bag 10 is therefore connected to the watch 8 by the wire 12. A serial number 15 of the bank note 9 is marked on the watch 8, for instance by etching on a rear surface (not shown) thereof.

In this embodiment of the invention, a prospective buyer of the watch 8 need only compare the serial number 15 of the bank note 9 attached to the watch 8 with that etched on the rear surface of the watch 8 to determine whether or not the watch 8 is a genuine article, or a counterfeit thereof. Only if the numbers match can the prospective buyer be confident that the watch 8 is genuine.

It is envisaged that the item whose authenticity is to be verified may be provided in a separate, preferably tamper-proof, package, for example a box. In this instance, a bank note may be physically associated with the package by attachment thereto, rather than being physically associated with the item itself. In this embodiment, the outward appearance of the item need not be disturbed by the presence of a bank note, and a consumer may still be confident upon purchase of the item that the item is an authentic one.

The present invention is not limited to the examples given above, and it will be clear to a person skilled in the art that any object may be packaged in a manner embodying the present invention in order to effectively combat counterfeiting thereof.

In the present specification “comprises” means “includes or consists of” and “comprising” means “including or consisting of”.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A method of preventing counterfeiting of an item, comprising the steps of:
providing an item, the authenticity of which is to be verified;
providing a bank note having a serial number marked thereon;
physically associating the bank note with the item; and
marking at least a part of the serial number on the item.

2. A method according to claim 1, wherein the at least part of the serial number comprises the whole of the serial number.

3. A method according to claim 1, wherein the step of physically associating the bank note with the item comprises the step of rendering the at least part of the serial number visible.

4. A method according to claim 1, wherein the item includes packaging, and the step of physically associating the bank note with the item comprises the step of physically associating the bank note with the packaging.

5. A method according to claim 1, wherein the step of physically associating the bank note with the item comprises the step of providing a transparent surface, the bank note being located between the item and the transparent surface.

6. A method according to claim 1, wherein the step of physically associating the bank note with the item comprises the steps of:
providing a bag having an at least partially transparent area; and
placing the bank note within the bag.

7. A method according to claim 1, further comprising the step of marking the at least part of the serial number of the bank note on the item in at least one further location.

8. A method according to Claim 1, further comprising the steps of:
providing at least one further bank note; and
physically associating the at least one further bank note with the item.

9. A method according to claim 8, wherein the step of providing at least one further bank note comprises the step of providing one further bank note.

10. A method according to claim 8, wherein the step of providing at least one further bank note comprises the step of providing two further bank notes.

11. A combination of an item, the authenticity of which is to be verified, and a bank note having a serial number marked thereon, wherein the bank note is physically associated with the item and the item has at least a part of the serial number of the bank note marked thereon.

12. A combination according to claim 11, wherein the at least part of the serial number comprises the whole of the serial number.

13. A combination according to claim 11, wherein at least part of the bank note is rendered visible.

14. A combination according to claim 11, further comprising a transparent surface, the bank note being located between the item and the transparent surface.

15. A combination according to claim 11, further comprising a bag having an at least partially transparent area, the bank note being located within the bag.

16. A combination according to claim 11, wherein the at least part of the serial number is marked in at least one further location on the item.
